(19) United States
(12) Patent Application Publication
(10) Pub. No.: US 2013/0195729 A1
(43) Pub. Date: Aug. 1, 2013

(54) On-Demand Gas Generator

(71) Applicant: Purdue Research Foundation, West Lafayette, IN (US)

(72) Inventors: Jerry M. Woodall, West Point, IN (US); Go Choi, West Lafayette, IN (US); George H. Goble, West Lafayette, IN (US)

(73) Assignee: PURDUE RESEARCH FOUNDATION, West Lafayette, IN (US)

(21) Appl. No.: 13/741,378

(22) Filed: Jan. 14, 2013

Related U.S. Application Data
(60) Provisional application No. 61/586,503, filed on Jan. 13, 2012.

(51) Int. Cl. C01B 3/08

(52) U.S. Cl. CPC C01B 3/08
USPC 422/162

(57) ABSTRACT

A gas generation apparatus includes a reaction vessel and a fluid reservoir. The reaction vessel has an internal container therein for a reactant material including a solid portion and a liquid portion. The internal container has a perforated upper portion suitable for containing said solid portion of said reactant material, and a solid lower portion suitable for containing said liquid portion of said reactant material. The fluid reservoir is external to the reaction vessel, and has a variable volume fluid chamber. The fluid reservoir is in fluid connection with the reaction vessel.

The present application claims the benefit of U.S. Provisional Patent Application Ser. No. 61/586,503, filed Jan. 13, 2012, which is incorporated herein by reference.

### FIELD OF THE INVENTION

The present invention relates to the field of gas generation and, more particularly, to an apparatus for controlling the generation of gas from a liquid/solid reaction or the like.

### BACKGROUND

Recent environmental concerns have led to increased focus on developing clean energy production methods to reduce the dependence on oil and to reduce the emission of hydrocarbons thought to be harmful to the environment. One such clean energy source is hydrogen. The main byproduct of hydrogen combustion is water. Generation of fuel grade hydrogen can involve the reaction of an alkali metal or a metal hydride that will react with water to form hydrogen gas. If this reaction is not controlled, it could result in dangerously high pressurization.

A variable-flow valve can regulate the flow rate at which the gas is delivered for an intended application, but the variable-flow valve without another control mechanism does not regulate the rate at which gas is generated. The prior art describes a variety of ways to manipulate a reaction which generates gas. However, the known methods of controlling gas generation involve either overly complex or fragile or expensive mechanisms.

One advancement that avoids some of the drawbacks of the prior art is disclosed in U.S. Pat. No. 8,080,233, which discloses a gas generator system having inherent control using two pressurized containers. The first container includes the reaction chamber, and the second is a fluid reservoir. High pressure in the reaction chamber causes the reactant fluid to pass back to the reservoir, thereby reducing the amount of fluid that is available with the other reactants in the reaction chamber. While this solution overcomes many drawbacks, there is a need for further flexibility in the types of reactants that may be employed, and/or in the convenience of use of the system.

Therefore, a need remains for improvements in control systems for on-demand gas generators.

### SUMMARY OF THE INVENTION

The present invention provides certain improvements on a self-regulating gas generation method and apparatus that includes a fixture for holding reactant material inside a reactor, and to a means for recharging the reactor, embodiments of which are described below. The fixture is manipulated to increase or decrease the amount of reactant material is available for gas generation.

A first embodiment is a gas generation apparatus that includes a reaction vessel and a fluid reservoir. The reaction vessel has an internal container therein for a reactant material including a solid portion and a liquid portion. The internal container has a perforated upper portion suitable for containing said solid portion of said reactant material, and a solid lower portion suitable for containing said liquid portion of said reactant material. The fluid reservoir is external to the reaction vessel, and has a variable volume fluid chamber. The fluid reservoir is in fluid connection with the reaction vessel.

This embodiment is useful, by way of non-limiting example, in a hydrogen generator in which water is contacted with a metal-based reactant. In this embodiment, the metal-based reactant may have a liquid portion and a solid portion, both of which are still contained in the internal container.

The above-described features and advantages, as well as others, will become more readily apparent to those of ordinary skill in the art by reference the following detailed description and accompanying drawings.

### BRIEF DESCRIPTION OF THE FIGURES

FIG. 1 is a diagram of a gas generator system according to the present disclosure.

FIG. 2 is a diagram of a gas generating system according to another disclosed embodiment.

FIG. 3 is a diagram of a gas generating system according to a further disclosed embodiment

### DETAILED DESCRIPTION OF PREFERRED EMBODIMENTS

For the purpose of promoting an understanding of the principles of the invention, reference will now be made to the embodiments illustrated in the drawing and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

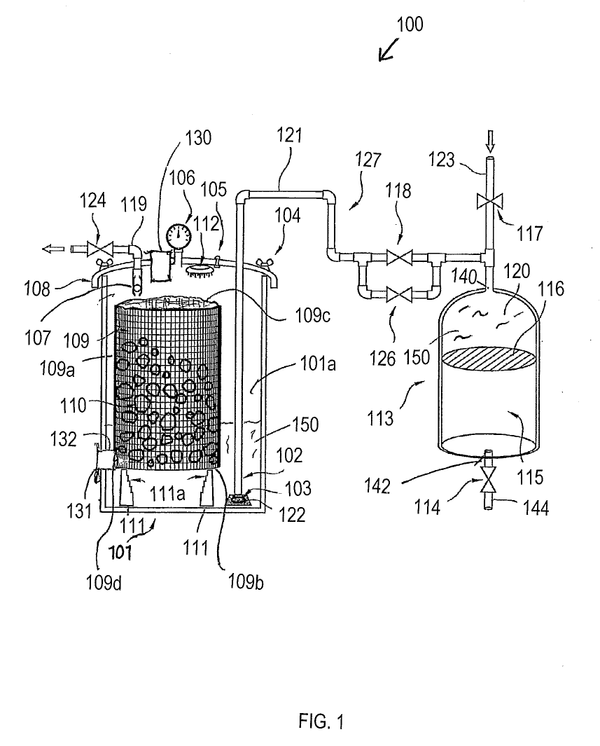

FIG. 1 shows a gas generator apparatus 100 according to a first embodiment. The gas generator 100 apparatus is configured to manipulate the generation of gas produced by reacting a solid-like, metal-based reactant with a liquid reactant. The apparatus 100 is adjustable to generate gas at a variety of pressures and thereby provide gas for a variety of applications. The apparatus 100 is self-regulating and provides for the gas generating reaction to slow when an upper pressure threshold of gas product exists and allows for the gas generation reaction to speed up when a lower threshold of gas product exists. The manipulation of the reaction includes the ability to select, vary, and spontaneously adjust the upper and lower pressure thresholds of the reaction to generate gas.

The use of aluminum as a means for producing heat and hydrogen has been disclosed in U.S. published patent application number 2008/0056986 A1, the disclosure of which is incorporated herein by reference. The gas is generated when a first (which may be liquid and/or solid) reactant and a liquid reactant (which may be water) come into contact with each other. For example, hydrogen gas may be generated by allowing water to contact aluminum. Gallium, gallium-indium, and other suitable alloys are desirable to use as an aluminum solvent because the gallium inhibits the passivating nature of aluminum oxide. The alloy of aluminum and gallium may form a solid or a solid-like mixture. The term “solid-like” used hereafter shall be understood to mean a traditional solid compound or a mixture in which the oxide forming source material is in its solid-state form and the passivation-preventing solvent is substantially in solid state, but may have some liquid-state inclusions depending on the temperature of the mixture.

As shown in FIG. 1, the apparatus 100 includes a reaction vessel 101 operably coupled to an expansion tank 113 via a fluid communication network 127. The reaction vessel 101 is a vessel configured to operate with and sustain internal pressure, and may suitably be a pressure pot or a “paint spray pot” commonly used to deliver paint for spraying operations. Such pressure pots are usually rated for about 80 psig pressure. One suitable pressure pot is the Graco model 236149, 5 gallon, 100 psig rated, stainless steel, ASME rated. Also suitable are the 10 gallon variety, Graco model 236150, and the 15 gallon variety, Graco model 236151.

The reaction vessel 101 defines a reaction chamber 101a in which the reaction that generates gas takes place. Fluid flows between the expansion tank 113 and the reaction vessel 101 via the fluid communication network 127. The expansion tank 113 may suitably be an expansion tank commonly used in hydronic heating systems or solar thermal hot water systems to allow the working fluid to expand and contract as the temperature changes. One suitable hydronic expansion tank is the Amtrol Extrol model 90 rated at 100 psig, 240 degrees Fahrenheit, and will accept 11.3 gallons of fluid.

The expansion tank 113 consists of a fluid chamber 120, a second chamber 114, and a flexible diaphragm 116. The flexible diaphragm 116 separates the fluid chamber 120 from the second chamber 115. To this end, the flexible diaphragm 116 is constructed such that it can bulge into the fluid chamber 120 thereby enlarging the volume of the second chamber 115 and decreasing the volume of the fluid chamber 120 or bulge into the second chamber 115 thereby decreasing the volume of the second chamber 115 and enlarging the volume of the fluid chamber 120. The flexible diaphragm 116 should be non-permeable, and may suitably be constructed of butyl rubber. The flexible diaphragm 116 provides a substantially fluid-tight and air-tight common border between the fluid chamber 120 and the second chamber 115 of the expansion tank 113.

The fluid chamber 120 is operably coupled to the reaction vessel 101 via the fluid communication network 127. As will be discussed below, the fluid communication network 127 may include a variety of fluid control means disposed between the fluid chamber 120 and the reaction vessel 101. In this embodiment, the fluid communication network 127 includes a pipe 121 or similar connection means like a hose, tubing, or other similar lines, and at least one valve 118. The valve 118 can be used to selectively restrict the flow of fluid between the fluid chamber 120 and the reaction vessel 101.

As shown in FIG. 1, the fluid chamber 120 includes a port 140 to facilitate filling the fluid chamber 120 with fluid. The port 140 is operably coupled to a line 123 through which fluid may be loaded into fluid chamber 120. The line 123 contains a second valve 117 through which the flow of fluid into the fluid chamber 120 can be selectively restricted. The line 123 is connected to a source of liquid, such as the plumbing of a building, not shown, or another type of fluid reservoir such as a tank, not shown. In an alternative embodiment, the reaction vessel 101 is loaded with fluid. In such an embodiment, pressure inside the reaction vessel 101 could force the fluid into the fluid chamber 120 through the fluid communication network 127. As a consequence, the line 123 and port 140 would not be necessary in such an embodiment.

The second chamber 115 also includes a port 142 coupled to a line 144 having a third valve 114. The second chamber 115 in this embodiment contains a pressurized gas. The pressure of the gas can be selected by filling or releasing gas from third valve 114. The higher the gas pressure in second chamber 115, the more the expansion of the fluid chamber 120 will be opposed. A lower gas pressure in second chamber 115 will oppose the expansion of fluid chamber 120 to a lesser extent.

In other embodiments, other means of opposing or favoring the expansion of the fluid chamber 120 may be employed. For example, instead of a second chamber 115 filled with gas, the flexible diaphragm 116 may instead be biased using a spring, a weight, a piston system or other similar means.

In any event, the pressure of the gas inside the second chamber 115 can be adjusted according to the desired pressure of the gas generated inside the reaction vessel 101. If a lower buildup pressure of product gas inside the reaction vessel 101 is desired, then the pressure of the gas inside second chamber 115 can be reduced so that the expansion of the fluid chamber 120 will be opposed less. As a result, a lower product pressure inside the reaction vessel 101 would be sufficient to cause the some of the fluid reactant to flow through the fluid communication network 127 into the fluid chamber 120. The opposite effect can be obtained by selecting a higher pressure of gas inside the second chamber 115 whereby a higher threshold of pressure inside the reaction vessel 101 is necessary to force the fluid through the fluid communication network 127 into the fluid chamber 120. One suitable implementation of the gas generation apparatus 100 employs 10-12 psig of gas inside the second chamber 115.

As mentioned above, the reaction vessel 101 in this embodiment defines a reaction chamber 101a that contains or supports a gas tube 119, a floating ball check valve 107, a pressure gauge 106, a reactant or internal container 109, a top port 130, a bottom port 131, and a conduit 132. The reaction vessel 101 includes a removable lid 108 and an over-pressure relief device 105.

The removable lid 108 is provided for filling or cleaning the reaction vessel 101. The lid 108 is secured on the top of the reaction vessel 101 with wing nuts 104 and corresponding bolts, not shown. The lid 108 and all other ports (e.g. ports 130, 131) in the reaction vessel 101 should form a seal capable of maintaining the operating pressure inside the reaction vessel 101. To this end, the 0-rings, not shown, may be employed between the lid 108 and the remainder of the reaction vessel 101. The over-pressure relief device 105, commonly called a “safety”, is also formed in the lid 108 in this embodiment. Regardless of the location, the over-pressure relief device 105 is a common device that is configured to permit gas to escape if the pressure inside the reaction vessel 101 reaches a threshold level which is not desired under normal operating conditions.

The pressure gauge 106 allows visual monitoring of the pressure inside the reaction vessel 101. The pressure gauge 106 can be incorporated into the lid 108 as shown in FIG. 1, or alternatively on another part of the reaction vessel 101. For some certain applications, the pressure gauge 106 should be configured to measures positive and negative pressure.

In FIG. 1, the gas line 119 of the reaction chamber 101a extends through the lid 108 to facilitate the delivery of gas from the reaction chamber 101a to the engine or other device, not shown, which consumes or otherwise uses or stored the produced gas. The gas line 119 may include a gas valve 124 for selectively and controllably releasing the gas from the reaction vessel 101.

The floating captive ball check valve 107 is disposed within the gas line 119 for the purpose of preventing liquid from escaping via the gas line 119 under certain circumstances. In particular, if during normal operation, the reactant 110 is consumed and product gas continues to be drawn from the reaction vessel 101, the water level may rise to the top of the reaction vessel 101, and could potentially exit out via the gas line 119. It is undesirable for the fluid reactant to enter an engine or other apparatus drawing the product gas. Accordingly, incorporating the floating captive ball check valve 107 in the gas line 119 can reduce the likelihood of the fluid reactant escaping through the gas line 119. The floating captive ball check valve 107 is comprised of a floating captive ball which floats upward within the gas line 119 as the fluid level rises. When the captive ball seats against the top of the valve 107, it seals the gas line 119 to prevent the egress of fluid. It will be appreciated that other floats or mechanisms may also be used as well to prevent egress of fluid. Nevertheless, the floating captive ball check valve or other mechanisms should be designed or adjusted so that high flow rates of gas do not unintentionally close the gas line 119.

The reactant or internal container 109 is disposed within the reaction vessel 101 and comprises a container having an outer cylindrical side wall 109a and a bottom wall 109b. It will be appreciated that the internal container 109 may have a non-cylindrical shape in other embodiments. In the embodiment, the side wall 109a and/or bottom wall 109b, or portions thereof, is/are semi-permeable to allow water or one reactant of the gas generation process to pass through, while not allowing other reactants of the gas generation process to pass through. More specifically, the semi-permeable portion preferably allows the passage of water and liquids of similar surface tension but is impermeable to liquid gallium, liquid Ga—In mixtures, liquid Al—Ga mixtures, and liquids of similar surface tension. The semi-permeable portion may be a membrane, tight mesh or other selective barrier structure, including one of approximately 200 mesh.

The top port 130 in this embodiment is formed in the lid 108 and may suitably be a valve, or an opening with a removable cap, having an orifice diameter of 2-3 inches. The top port 130 may be used for recharging the reactor apparatus 100. For example, a hose and pump setup could be used to pump small solid In—Ga pellets followed by Al—Sn pellets through the top port and into an open top 109c of the internal container 109.

The bottom port or drain valve 131 of the reaction vessel 101 is provided for removing spent reactant material and reaction byproducts as part of the recharging process, and it is preferably coupled to a port 109d in a bottom portion of the internal container 109 via a short conduit 132 which may be plugged during normal operation of the hydrogen generator 100. The reactant material 110 removed may be drained into a separate holding tank for recycling. For example, the gallium can be reused, and the aluminum hydroxide reaction product can be recycled back into metallic aluminum via the Hall process. Thus, the reactor can be recharged on site, and only the holding tank need be transported to a recycling location.

In the embodiment, described herein, the apparatus 100 further includes spacers 111 to locate the internal container 109 at various vertical positions inside the reaction vessel 101 (e.g., bottom, middle, and top), which can be used to vary the working volume of the gas generated inside the reaction vessel 101. To this end, the working volume is the volume of the reaction vessel 101 above the liquid reactant. The spacers 111 may be affixed to the bottom or side by any suitable means whereby the position of the perforated basket inside the pressure pot 1 can be varied. The spacers 111 may suitable includes spaced steps 111a on which the internal container 109 may rest. However, other designs capable of providing adjustable support (or even nonadjustable support) may be employed.

The fluid communication network 127 includes a terminal orifice 122, a filter 103, a dip tube 102, one or more pipes 121, a valve 118, and a check valve 126. The terminal orifice 122 is disposed inside the reaction vessel 101. In the embodiment described herein, the terminal orifice 122 is positioned at a level below where the reactant 110 is positioned. Thus, for example, the terminal orifice is disposed on a vertical level below the vertical level of the bottom of the internal container 109. In this orientation, as the pressure builds from the generation of gas, the increase in pressure will force the some of the fluid through the fluid communication network 127 and the level of the fluid reactant will decrease. If the pressure is sufficient the level of the fluid will drop below the level of the reactant 110. Separating the reactants will slow the reaction and soon thereafter the reaction will cease if the fluid reactant and the solid-like reactant remain separated. FIG. 1 shows the orifice 122 positioned near the bottom of the reaction vessel 101.

The dip tube 102, also known as an eductor tube, is coupled to run from the terminal orifice 122 to the pipe 121, which is located external to the reaction vessel 101. The filter 103 is included to prevent any solid reaction byproducts from entering the port orifice 122 and reaching the fluid chamber 120. In the embodiment illustrated in FIG. 1, the filter 103 is positioned to surround the orifice 122. The filter 103 may be constructed to include cloth, foam, metal or any other suitable strainer means for preventing solid material from entering the dip tube 102.

To operate the disclosed gas generator 100, a metal-based reactant 110 is loaded into the internal container 109 via the top port 130, or alternatively by removing the lid 108. This embodiment is particularly suited for containing reactant material which includes a liquid or a liquid mixture, e.g., liquid gallium. For example, the metal-based reactant 110 may be a solid Al—Sn bulk alloy and a liquid mixture of gallium and indium. The reactant material may be introduced in the form of Al—Sn pellets and In—Ga pellets, and the In—Ga pellets will melt in the “tub” at or about normal room temperature or otherwise be made to melt. When this reactant material 110 is exposed to a desired fluid reactant 150 such as water, the tight mesh (and/or any walls) of the internal container 109 keep the liquid portion of the reactant 110 in place during the soaking step and supplies the liquid Ga needed to continuously dissolve the Al at the grain boundary water interface when hydrogen gas is generated.

In any event, to continue with the operation, the valve 118 leading to the expansion tank 113 is closed. The fluid reactant 150 is loaded into the fluid chamber 120 of the expansion tank 113 via the valve 117. The valve 117 may be closed after the fluid reactant 150 has been loaded if the fluid reactant volume is to remain fixed during the reaction. The ambient air may be evacuated from the reaction vessel 101 through the gas line 119 and the gas valve 124 by using a vacuum pump, not shown. For example, the extent of evacuation may be about 29 inches of vacuum pressure or better (less than 1 percent air remaining). The ambient air should be evacuated to reduce the ambient environmental impurities in the desired reaction product.

The selected volume of the fluid added to the fluid chamber 120 should be balanced with the desired/selected pressure of the gas inside the second chamber 115. The extent of evacuation in the reaction vessel 101 will also affect the flow of the fluid reactant 150 from the fluid chamber 120 to the reaction vessel 101. A combination of fluid volume, second chamber pressure, and extent of pressure pot evacuation should be sufficient to force the fluid to enter the reaction vessel 101 via the fluid communication network 127.

The fluid chamber 120 may be loaded by supplying the fluid 150 under pressure such as the pressure supplied by the fluid supply coupled to the line 123. As discussed further above, the fluid supply can be a conventional water supply plumbing system. The fluid 150 may also be pumped into the fluid chamber 120 so that the flexible diaphragm 116 bulges into the second chamber 115. The fluid 150 may be funneled into the fluid chamber 120 under atmospheric conditions if the second chamber 115 is not pressurized above atmospheric conditions. The fluid 150 loaded under atmospheric conditions can be charged by subsequently increasing the pressure in the second chamber 115 by adding compressed gas through the valve 114.

After filling the fluid chamber 120 with fluid reactant 150, any entrapped gas should is bled out of the fluid chamber 120 via the valve 117 when the valve 117 is disconnected from a fluid supply system.

It will be appreciated that when the fluid reactant 150 is water, and the reactant 110 in the internal container 109 includes aluminum and gallium, such as when the reactant 110 comprises a solid Al—Sn bulk alloy and a liquid mixture of gallium and indium, the interface or mixture of the reactants within the reaction vessel 101, and more specifically, within the internal container 109, hydrogen gas, aluminum oxide, and heat will be products of the reaction.

To this end, the reaction is ready to begin when the fluid 150 in the fluid chamber 120 is charged relative to the pressure in the second chamber 115 and relative to the vacuum in the reaction vessel 101 to sufficiently force the fluid 150 into the reaction vessel 101. It will be appreciated that, in general, the valve 118 should be opened to allow the fluid reactant 150 to flow into the reaction vessel 101 via the fluid communication network 127. The reaction will be initiated when the fluid reactant 150 and the metal reactant 110 are in contact. The reaction produces hydrogen gas in this embodiment, as discussed above.

The produced gas exits via the gas line 119 and valve 124 to its intended destination. To this end, as the gas evolves, it rises to the top and exits through the gas line 119. If the gas pressure builds pressure because the gas is not dispersed through valve 124 faster than the gas is generated, then some of the fluid 150 is forced down within the reaction vessel 101, through the fluid communication network 127, and into the expandable fluid reservoir 120, resulting in a lowered level of fluid 150 in the reaction vessel 101. The reaction slows or stops when the pressure inside the reaction vessel 101 forces the fluid 150 to a level where the fluid reactant contact with the metal-based reactant 110 is diminished. Furthermore, if additional product gas is not drawn off via the gas line 119, then the pressure can build to a point where the fluid reactant 150 is no longer in contact with the metal reactant 110 within the container 109, and an equilibrium level of the fluid 150 will be reached. The fluid reactant 150 will remain out of contact with the metal reactant 110 until a change in the system 100 occurs which brings the fluid reactant 150 back into contact with the reactant 110 within the internal container 109.

When additional gas product is drawn from valve 124, the resultant decrease in pressure inside the reaction vessel 101 allows the level of the fluid reactant 150 to rise. To this end, the fluid 150 is drawn from the fluid chamber 120 and through the fluid communication network 127. The volume of fluid reactant 150 in reaction vessel 101 increases. If a sufficient decrease in pressure occurs the fluid reactant 150 contacts the metal reactant 110, and gas generation again occurs. The reaction will proceed as previously disclosed until the pressure inside the reaction vessel 101 reaches a threshold that is sufficient to expel a volume of fluid reactant from the pressure pot wherein contact between the fluid reactant 150 and the solid-like metal reactant 110 diminishes.

The system 100 can change in other ways other than drawing off the reactant product whereby the reaction can be initiated or concluded. The system 100 can be altered by adjusting the pressure in the second chamber 115 through adding or releasing air through the valve 114. Increasing the pressure in the second chamber 115 can force more fluid 150 to exit the fluid chamber 120 and enter the reaction vessel 101. The reaction can be initiated if the fluid level increase is sufficient to initiate contact with the metal-based reactant 110 within the internal container 109. Contrariwise, decreasing the pressure in the second chamber 115 can force the fluid to exit the reaction vessel 101, enter the fluid reservoir 113, and the reaction can be concluded if the drop in fluid level in the reaction vessel 101 is sufficient to separate the reactants 110, 150.

The volume of fluid reactant 150 can also be adjusted by adding or releasing fluid though the valve 117. Adding more fluid 150 to the system can supply more fluid to the reaction vessel 101 and initiate the reaction if the increase in fluid 150 is sufficient to initiate contact with the metal-based reactant 110. Removing fluid 150 from the system 100 can reduce the supply of fluid 150 in the reaction vessel 101. These manipulations of the reaction parameters provide the ability to select, vary, and spontaneously adjust the upper and lower pressure thresholds of the reaction to generate gas. These manipulations may be made during setup of the apparatus 100 or on-the-fly during operation thereof.

This embodiment may optionally include fixing a platinum catalyst 112 such as one or more “Hydrocap(s)™” inside the tank. Said catalyst will react any stray oxygen present due to incomplete evacuation or operational error with hydrogen to form water, thus removing the stray oxygen and reducing the explosion hazard if a flashback were to occur from the apparatus (e.g., internal combustion engine) drawing the hydrogen. Platinum catalysts are designed to be used on flooded wet cell deep cycle lead acid batteries and recombine hydrogen and oxygen gases liberated during charging, thus greatly reducing the amount of watering needed. The platinum catalyst 112 should be located above the level where the fluid 150 is expected to occupy during normal operation. The platinum catalyst 112 may suitably be affixed to the lid 108.

An additional safety-related option is provided by the check valve 126. The check valve 126 is a one-way check valve connected in parallel with the valve 118 to allow flow toward the fluid reservoir 120 even if the valve 118 is closed. The check valve eliminates the potential for an operator to inadvertently close the valve 118 while the apparatus 100 is in operation thereby trapping the fluid reactant 150 in the reaction vessel 101. Closing the valve 18 without a one-way check valve in place could result in excessive gas pressure buildup in the reaction vessel 101.

In some embodiments, the apparatus may further include a temperature control system. The reaction between the solid-like reactant and the fluid reactant is exothermic. Operating the apparatus 100 at a higher reaction rate can cause the temperature inside the reaction vessel 101 to increase. The upper limit of the suitable operating temperature and pressure will be determined by the specifications of the reaction vessel 101 and the expansion tank 113 chosen to practice the invention. A suitable temperature range when practicing the invention using the disclosed materials is 200-400 degrees Fahrenheit. Some rates of reaction can produce temperatures higher than the suitable operating temperature of the apparatus 100 and a means to control the temperature may be necessary. In one embodiment, the temperature control means is an external cooling jacket, not shown, wrapped around the outside of the reaction vessel 101. The cooling jacket may either have refrigerant flowing through the jacket or the cooling jacket may be a type of heat pipe in which the heat is used to evaporate a coolant in a closed system wherein the heat is dissipated in the condensing area of the heat pipe. In another embodiment the same methods of cooling may also be applied to the inside of the reaction vessel 101. In such an embodiment the pressure pot is be fitted with coils which provide for a flow of coolant to enter and exit the inside of the reaction vessel 101 or the coils may be a type of heat pipe wherein the condensing area of the heat pipe is located externally of the reaction vessel 101.

At some temperatures and pressures the fluid reactant 150 may vaporize and exit with product gas if a cooling means is not used to keep the reaction vessel 101 below the vaporization temperature of the fluid reactant 150. Allowing the fluid reactant to leave the pressure pot with the product gas may be acceptable provided accommodations are made for the exit gas to contain both product gas and fluid reactant vapor. A recapture system, not shown, may be implemented in one embodiment where the exit gas is passed through a condenser having a temperature at which the fluid reactant vapor will condense but the product gas will not condense. After passing through the condenser the fluid vapor would be substantially separated from the product gas. The fluid reactant vapor could be collected and supplied back into the system. The condensed fluid reactant should be prevented from dripping onto the solid-like reactants during the re-supply process. Feeding the recaptured fluid reactant into the dip tube 102 would be a suitable re-supply location.

In an alternative embodiment the exiting gas stream composed of both the generated gas and fluid reactant vapor could be used to drive a Stirling engine, steam engine, turbine, expander, or other device to extract useful work from the waste heat. When this technique is implemented the system will eventually need to be re-supplied with fluid reactant. This method and the other methods of removing the heat from the pressure pot can be used as a source for a combined heat and power system.

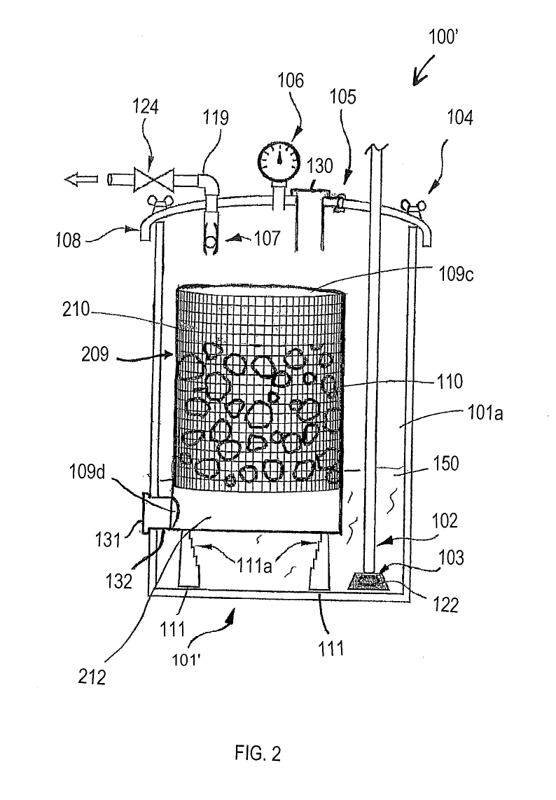

FIG. 2 shows the reaction vessel 101′ and reaction chamber 101a′ of an alternative embodiment that may be used to replace the reaction vessel 101 and reaction chamber 101a in the generator apparatus 100 of FIG. 1. The reaction vessel 101′ and reaction chamber 101a′ include many identical structures as those shown in FIG. 1. However, the embodiment of FIG. 2 employs an alternative internal container 209 instead of the internal container 109 of FIG. 1. The internal container 209, similar to the container 109, is also designed to operate with the metal based reactant 110 having at least some liquid or liquid mixture. As shown in FIG. 2, the internal container 209 includes a wire-like basket or perforated upper portion 210 and a solid tub-like bottom portion 212. In one embodiment, the wire-like basket upper portion 210 is a wire basket or other perforated container that is disposed in and extends above a solid tub that forms the bottom portion 212. As with the embodiment of FIG. 1, this embodiment is particularly suited for containing reactant material which includes a liquid or a liquid mixture, e.g., liquid gallium. For example, the basket with tub-like bottom may contain a solid Al—Sn bulk alloy and a liquid mixture of gallium and indium. The reactant material may be introduced in the form of Al—Sn pellets and In—Ga pellets, and the In—Ga pellets will melt in the “tub” at or about normal room temperature or otherwise be made to melt. When this reactant material is exposed to a desired fluid reactant such as water, the tub-like bottom portion 212 keeps the liquid in place during the soaking step and supplies the liquid Ga needed to continuously dissolve the Al at the grain boundary water interface, and hydrogen gas is generated.

As opposed to the embodiment of FIG. 1, however, the perforated upper portion 210 need not be impermeable to the liquid portions of the metal based reactant 110, because such portions are contained by the tub-like bottom portion 212. Otherwise, the remaining portions of the apparatus 100′ of FIG. 2 may suitably be the same as those of the apparatus 100 of FIG. 1.

Similar to the embodiment of FIG. 1, as the hydrogen gas is generated, it rises to the top, and builds pressure if the gas is not dispersed through the valve 124 faster than the gas is generated. As the pressure builds, some of the water/reactant 150 is forced down in the reaction vessel 101, through the fluid communication network 127, and into the expandable fluid reservoir 120 resulting in a lowered level of fluid reactant 150 in the reaction vessel 101. In this embodiment, however, the reaction slows or stops when the level of the fluid reactant 150 is below the top of the tub-like bottom portion 212, and any remaining fluid reactant 150 in the tub-like bottom portion 212 is consumed by the reaction.

The fluid reactant 150 will remain out of contact with the reactant material 110 in the internal container 209 until a change in the system occurs. For example, when additional product is drawn from the valve 124, the resultant decrease in pressure inside the pressure pot will allow the fluid level to rise. The fluid 150 is drawn from the fluid chamber 120 and through the fluid communication network 127. If the fluid level rises enough for water to enter the tub-like bottom portion 212, the fluid reactant 150 again contacts the reactant material and gas generation resumes. The reaction will proceed as previously disclosed until the pressure inside the pressure pot reaches a threshold that is sufficient to lower the fluid reactant level and diminish contact between the fluid reactant 150 and the reactants 110 in the internal container 209.

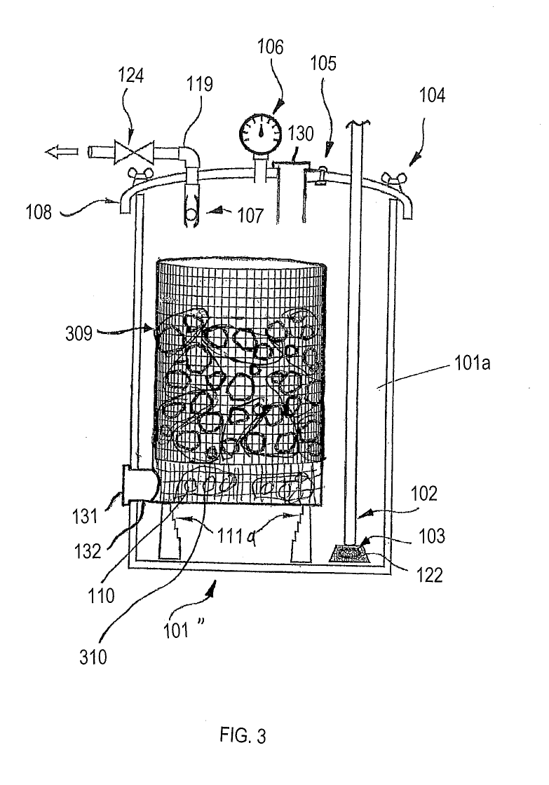

FIG. 3 shows another embodiment of a reaction vessel 101″ and reaction chamber 101a″ having an internal container 309 that may be used instead of the internal container 109 in the apparatus of FIG. 1. The internal container 309 is a cage, basket or the like which is permeable to water, and may also be permeable to gallium and liquid-phase alloys, similar to the upper portion 210 of FIG. 2.

In this embodiment, the reactant 110 may suitably be in the form of Al—Sn pellets and Gain pellets. However, the reactant is contained in readily removable smaller containers 310, e.g., bags, pouches, packets, capsules or the like, which are semi-permeable as described above, e.g., permeable to water but impermeable to gallium and the liquid-phase alloys mentioned above. The smaller containers 310 are sized such that several may fit within the internal container 309. The smaller containers 310 may be loaded with the above reactant material and then placed in the internal container 309 inside the reaction vessel 101 (or other reaction vessel). The smaller containers 309 may be made of cotton or other natural or synthetic fabric material which is semipermeable itself or is made with one or more membranes or other semi-permeable portions therein. Cotton socks, as one specific example, may be washed in a washing machine after use.

Further details on reactant materials useful in the present invention may be found in U.S. Pat. No. 8,080,233, issued Dec. 20, 2011, and in U.S. patent application Ser. No. 13/218,033, filed Aug. 25, 2011, which patent and patent application are hereby incorporated by reference along with all references cited therein.

It will be appreciated that other embodiments of the invention may omit one of or more of the features described above. For example, the internal containers 109, 209, and/or 309 may include a lid, not shown, to prevent the solid-like reactant 110 from floating if the solid reactant is less dense than the fluid reactant 150. The lid also secures any solid-like reactant 110 inside the internal container in the event that the effervescence generated by the reaction becomes vigorous to the point that the effervescence could displace the solid-like reactant from the internal container. The lid can be detachably secured to the internal container by any suitable means.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed:

1. A gas generation apparatus, comprising:
a reaction vessel having an internal container therein for a reactant material including a solid portion and a liquid portion, said internal container having a perforated upper portion suitable for containing said solid portion of said reactant material, and a solid lower portion suitable for containing said liquid portion of said reactant material;
a fluid reservoir external to said reaction vessel, said fluid reservoir having a variable volume fluid chamber; and
wherein the fluid reservoir is in fluid connection with the reaction vessel.

2. The gas generation apparatus of claim 1, wherein the fluid reservoir further includes a second chamber and a flexible barrier disposed between the fluid chamber and the second chamber.

3. The gas generation apparatus of claim 2, further comprising a fluid communication network operably coupling the reaction vessel with the fluid chamber.

4. The gas generation apparatus of claim 3, wherein the fluid communication network includes at least one conduit having a first orifice disposed within the reaction chamber at a vertical level that is below the perforated upper portion of the internal container.

5. The gas generation apparatus of claim 4, wherein the vertical level is below the solid lower portion of the internal container.

6. The gas generation apparatus of claim 4, further comprising a first port in the solid lower portion of the internal container, a second port in the reaction vessel, the second port in fluid communication with the first port, wherein the second port is accessible from an exterior of the reaction vessel.

7. The gas generation apparatus of claim 6, wherein at least a part of the second port is at a vertical level at or below at least a part of the first port.

8. The gas generation apparatus of claim 2, wherein the reaction vessel comprises a pressure pot.

9. A gas generation apparatus, comprising:
a reaction vessel defining a reaction chamber, the reaction vessel having an internal container within the reaction chamber for receiving a reactive metal element, the reaction vessel further configured to receive a reactant fluid at least a portion of which is disposed exterior to the internal container, the internal container having a first port disposed proximate a bottom portion thereof, the reaction vessel including a second port in communication with the first port, the second port accessible from an exterior of the reaction vessel;
a fluid reservoir external to said reaction vessel, said fluid reservoir having a variable volume fluid chamber, a second chamber and a flexible barrier disposed between the fluid chamber and the second chamber; and
wherein the fluid reservoir is in fluid connection with the reaction vessel.

10. The gas generation apparatus of claim 9, wherein the internal container internal container comprises a perforated upper portion, and wherein the bottom portion comprises a solid lower portion suitable for containing liquid.

11. The gas generation apparatus of claim 9, wherein the internal container includes at least one semi-permeable portion configured to allow the reactant flow therethrough, and which is further configured to substantially prohibit the flow of a second reactant in liquid state to flow therethrough.

12. The gas generation apparatus of claim 11, further comprising a fluid communication network operably coupling the reaction vessel with the fluid chamber.

13. The gas generation apparatus of claim 12, wherein the fluid communication network includes at least one conduit having a first orifice disposed within the reaction chamber at a vertical level that is below the bottom portion of the internal container.

14. The gas generation apparatus of claim 13, wherein the fluid communication network includes at least one pipe disposed exterior to the reaction vessel.

15. The gas generation apparatus of claim 14, further comprising an adjustable valve operably coupled to adjust flow through the at least one pipe.

16. The gas generation apparatus of claim 11, wherein the at least one semi-permeable portion is configured to allow water flow therethrough.

17. The gas generation apparatus of claim 16, wherein the at least one semi-permeable portion is configured to substantially prohibit the flow therethrough of at least one of the group consisting of liquid gallium, liquid Ga—In mixtures, and liquid Al—Ga mixtures.

18. A hydrogen generator, comprising:
a pressure vessel having a porous internal container which is permeable to gallium and liquid mixtures of gallium and indium or aluminum;
a plurality of flexible containers which are permeable to water but impermeable to gallium and liquid mixtures of gallium and indium or aluminum, said flexible containers sized to fit within said porous internal container in said pressure vessel;
a fluid source external to said pressure vessel; and
a fluid communication means between said pressure vessel and said fluid source.

19. The hydrogen generator of claim 18, further comprising:
a fluid reservoir external to said reaction vessel, said fluid reservoir having a variable volume fluid chamber; and
wherein the fluid reservoir is in fluid connection with the reaction vessel.
